(19) United States
(12) Patent Application Publication
(10) Pub. No.: US 2008/0129984 A1
(43) Pub. Date: Jun. 5, 2008

(54) Inspection of optical elements

(75) Inventor: Sam Cowley, Mountain View, CA (US)

Correspondence Address: Trellis Intellectual Property Law Group, PC, 1900 EMBARCADERO ROAD, SUITE 109, PALO ALTO, CA, 94303, US

(73) Assignee: Sol Focus, Inc., Palo Alto, CA (US)

(21) Appl. No.: 11/607,684

(22) Filed: Dec. 1, 2006

(51) Int. Cl. G01B 9/00

(52) U.S. Cl. 356/124

(57) ABSTRACT

In one embodiment, a method is provided that determines an image captured from a capture device. For example, a digital camera may be used to take an image of a pattern that is reflected off a solar optical element. The captured image is then compared to a master image. The master image may be an image taken of the pattern reflected off of a second optical element that is of a known distortion. A deviation between the captured image and the master image is then determined based on the comparison. For example, image processing software may use detection techniques to determine if any deviation between the captured image and the master image is present. The deviation may be stored or displayed and a determination as to whether the solar mirror passes or fails the test may also be determined.

### BACKGROUND

Particular embodiments generally relate to the testing of optical elements and more specifically to testing of optical elements for use in a solar power generation system.

Solar energy has long held great promise to a solution of the world's energy problems. Solar power generation has already proven to be very effective and environmentally friendly. This has made the appeal of solar energy more popular.

One example of a solar power generation system may include panels or arrays of photovoltaic cells. In a concentrator type of design, optical elements such as mirrors and lenses are used to concentrate sunlight from a larger area to a smaller focused area that is occupied by one or more cells. The optical elements include curved surfaces that focus the sunlight. Testing of these curved surfaces is necessary to determine if the optical element properly focuses the sunlight. If the sunlight is not properly focused, then the sunlight may not be concentrated correctly and thus the system may not properly generate energy. Typical methodologies for inspecting curved surfaces include equipment that is heavy and very costly. Further, the set-up is labor intensive and also may incur issues in setting the system up.

### SUMMARY

Particular embodiments generally relate to the testing of optical elements using an image captured using a capture device.

In one embodiment, a method is provided that determines an image captured from a capture device. For example, a digital camera may be used to take an image of a pattern that is reflected off a solar optical element. The captured image is then compared to a master image. The master image may be an image taken of the pattern reflected off of a second optical element that is of a known distortion. A deviation between the captured image and the master image is then determined based on the comparison. For example, image processing software may use detection techniques to determine if any deviation between the captured image and the master image is present. The deviation may be stored or displayed and a determination as to whether the solar mirror passes or fails the test may also be determined.

A further understanding of the nature and the advantages of particular embodiments disclosed herein may be realized by reference to the remaining portions of the specification and the attached drawings.

### BRIEF DESCRIPTION OF THE DRAWINGS

FIG. 1 depicts a simplified system for testing of an optical element according to one embodiment.

FIG. 2 depicts an example pattern according to one embodiment.

FIG. 3 depicts a testing system according to one embodiment of the present invention.

FIG. 4A depicts an example of a master image according to one embodiment of the present invention.

FIG. 4B depicts an example of a captured image according to one embodiment.

FIG. 5 depicts a simplified method of a flowchart for testing an optical element according to one embodiment.

FIG. 6 depicts another embodiment of a testing system according to one embodiment of the present invention.

FIG. 7 depicts another embodiment of a testing system according to embodiments of the present invention.

FIG. 8 depicts an example system incorporating the optical element according to one embodiment.

### DETAILED DESCRIPTION

FIG. 1 depicts a simplified system 100 for testing of an optical element 106 according to one embodiment. As shown, system 100 includes a capture device 102, an image processor 104, an optical element 106, and a pattern 108.

Capture device 102 is configured to capture an image reflected off of optical element 106. In one embodiment, capture device 102 may be any device configured to capture digital images. For example, capture device 102 may include a digital camera. Capture device 102 may also capture non-digital images, which can then be digitized using known methods.

Optical element 106 may be any reflective or refractive surface. For example, optical element 106 may be a mirror, glass, etc. In one embodiment, optical element 106 may be concave and can reflect light. In another embodiment, optical element 106 may be convex and can refract light. Although only one optical element 106 is shown in FIG. 1, as will be discussed in more detail below, multiple optical elements 106 may be included. In general, any number, type and arrangement of optical elements can be used with the present invention.

In one embodiment, optical element 106 reflects or concentrates light to a focus area. The term reflection will be used for discussion purposes, but it will be understood that optical elements 106 that refract light may also be tested. The focus area may be an area that is smaller in diameter than the diameter of optical element 106. In one example, the area may be a small percentage of the area of optical element.

A pattern 108 may include any pattern. For example, the pattern may be any type of information, such as a series of boxes, concentric circles, a series of shapes arranged in a pattern, a pattern of lines, different colors, or any other arrangement that can produce an image with a pattern. Also, the pattern may be dynamic instead of static. For example, blinking lights may be used to create a pattern. Thus, the pattern may be any item that can be reflected off of optical element 106 such that an image can be taken of the reflected pattern.

Pattern 108 is situated such that an image can be reflected off of optical element 106. Pattern 108 may be formed on any item, such as a flat material. In one embodiment, the pattern may be printed on any material, such as paper, cardboard, wood, metal, etc. The pattern itself may be opaque (i.e., reflective) or transparent (i.e., transmissive). In the case of an opaque pattern, a light source to illuminate the pattern would be placed on the optical element side of the pattern. In the case of a transparent pattern, a light source would be placed on the capture device side of the pattern.

As shown, an image may be reflected off of optical element 106 towards capture device 102. In one embodiment, optical element 106 focuses the image of the pattern to the focus area. Capture device 102 may be placed in a position to capture the image of the pattern substantially at the focus area. For example, capture device 102 may be placed close to the focus area and can capture the image at that area. In a particular embodiment, the capture device is aligned closely or precisely with the location of a photovoltaic cell to be later installed at the focus area. This allows measurement of optical element 106 with respect to the plane and area of the photovoltaic cell, so-that the finished assembly may be correctly aligned to maximize concentration of energy onto the cell. In other embodiments it is possible to place capture device 102 at a position other than the future location of the cell. For example, capture device 102 can be placed behind the cell's location, only partially overlapping with the cell's location, etc.

As shown, pattern 108 is positioned away from optical element 106. Accordingly, the pattern is reflected off of optical element 106 and the reflected image is captured by capture device 102. This is different from placing a pattern on optical element 106 and capturing an image of the pattern found on optical element 106. The capturing of-an image reflected off of optical element 106 allows the testing of a reflection that concentrates the image of the pattern to a focus area. This is a useful test for solar elements that are concentrators, i.e., solar elements that concentrate light to a focus area. In this case, it is expected that optical element 106 may focus light to a focus area from which capture device 102 takes an image. The focus area may be where a second optical element may reflect the light to a photovoltaic cell.

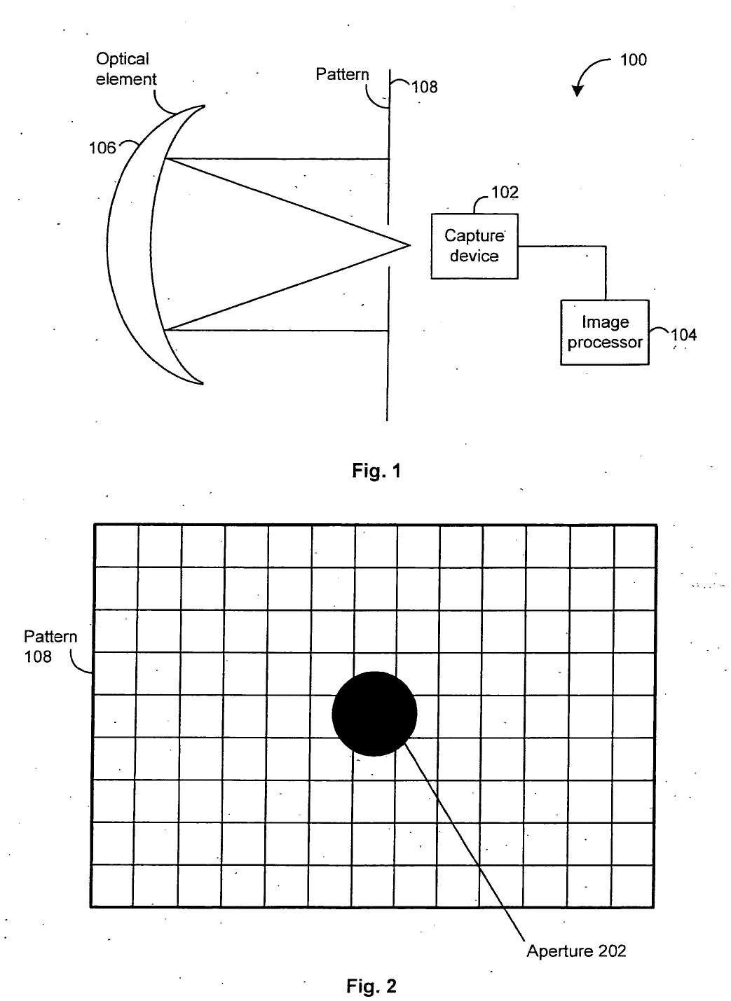

FIG. 2 depicts an example pattern 108 according to one embodiment. As shown, multiple lines criss-cross to form the pattern. An aperture 202 may be included in pattern 108. Aperture 202 allows capture device 102 to capture the image reflected off of optical element 106. Aperture 202 may be positioned such that it is in the focus area of the pattern reflected off of optical element 106.

Referring back to FIG. 1, capture device 102 may capture an image in any form, such as in a digital image. For example, the image may be captured as a raw bit map or any other suitable format such as jpg, gif, tif, etc. can be used. In other embodiments, other forms of data representation can be used such as digital or analog still images or video, or conversion of the image into a math model, data file, symbol file, etc.

Image processor 104 receives the captured image and can determine any deviation from the captured image from a master pattern. Image processor 104 may be separate from capture device 102 or be part of it. In one example, the captured image may be uploaded to a computing device and stored. Image processor 104 may then retrieve the image to determine the deviation.

A master image may be an image taken of a second optical element 106 of a known distortion. For example, the master image may be considered the standard image received from an acceptable optical element 106.

Image processor 104 is configured to determine any deviation between the captured image and the master image using different techniques. In one embodiment, edge detection techniques may be used to determine the deviation. The edges of the lines are determined from the raw bit map and then compared to another edge detection of the master image. Other techniques may also be appreciated. In general, unless otherwise stated, the steps, methods, and techniques described herein can be performed by manual, automated or a combination of manual and automated approaches.

In one embodiment, a characteristic of optical element 106 is tested. For example, surface aberration of optical element 106 may be measured. The deviation determined may be used to estimate the surface aberration of optical element 106 to the optical element used to generate the master image. In one example, the test may be whether the surface aberration is acceptable or not. The test may determine if the deviation is more than a predetermined threshold. If so, then the surface aberration may be considered too great and optical element 106 may fail the test. Other measurements that may be performed are the optical precision of optical element 106, a surface map, the alignment of optical element 106 to the focus area, curvature of optical element 106, etc.

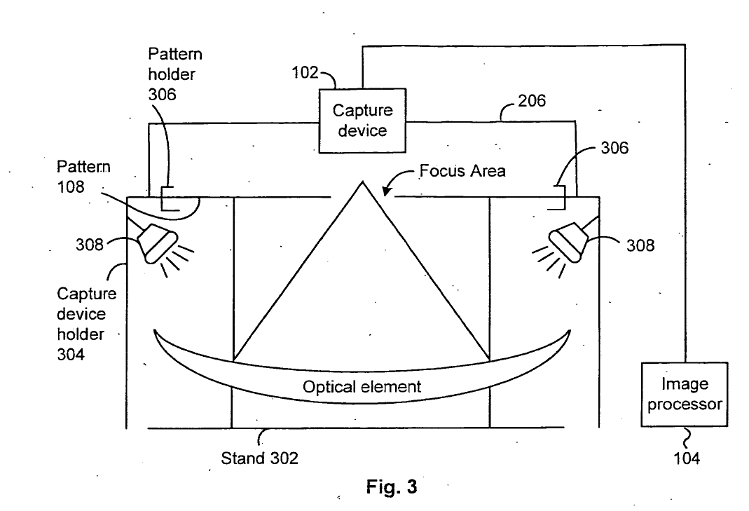

FIG. 3 depicts a testing system 300 according to one embodiment of the present invention. As shown, system 300 includes an optical stand 302, a capture device holder 304, a pattern holder 306, and a light source 308. Although this system is described, it will be understood that other systems may be appreciated.

Optical element 106 may be placed on optical stand 302. In one embodiment, optical stand 302 may be used to align optical element 106 in a solar power generation system. The alignment is necessary such that light rays may be concentrated correctly to the focus area.

Capture device holder 304 and pattern holder 306 hold capture device 102 and pattern 108, respectively. As shown, pattern holder 306 holds pattern 108 is a position away from optical element 106. Thus, the pattern that is found on the surface of pattern 108 is reflected off of optical element 106 to the focus area.

Capture device holder 304 positions capture device 102 such that it can capture an image at the focus area. As shown, capture device 102 is situated above image to be captured 108.

Light source 308 is configured to shine light (or any other electromagnetic radiation) onto optical element 106. This causes a reflection of pattern 108 off of optical element 106. As shown, the pattern is reflected off of optical element 106 to the focus area. Capture device 102 can then capture an image of the reflection.

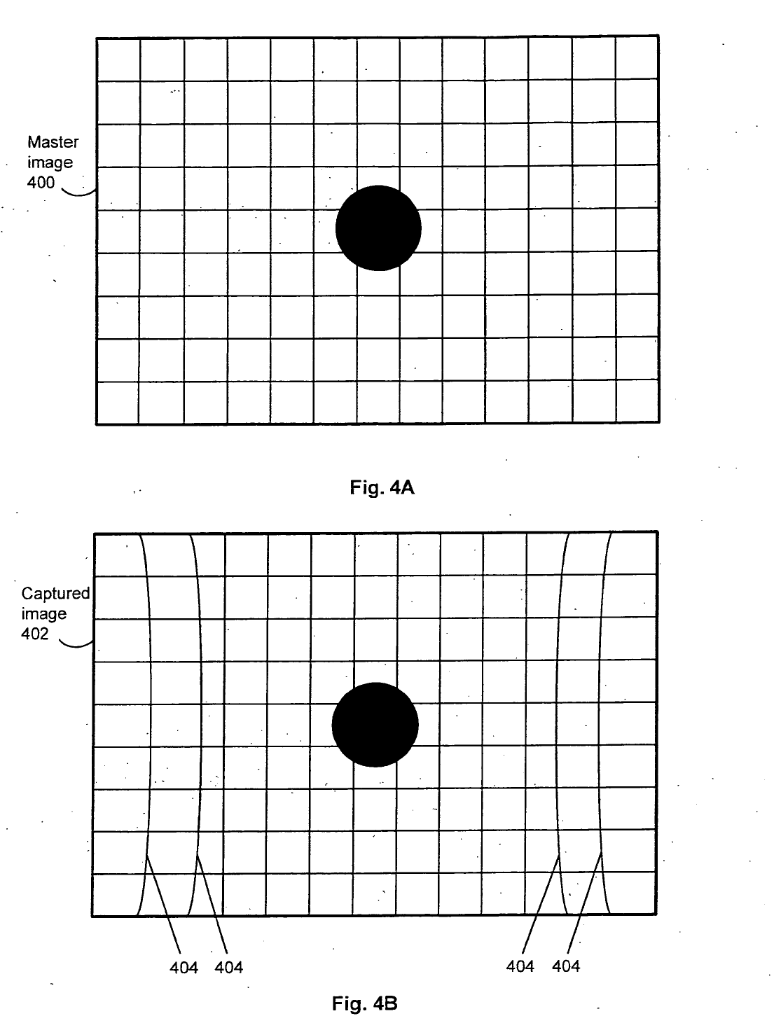

FIG. 4A depicts an example of a master image 400 according to one embodiment of the present invention. As shown, the pattern in image 400 looks substantially like the pattern 108. In this case, a second optical element 106 was used to reflect the image. The distortion in this case is minimal. It should be noted that more distortion could be present if one desired a mirror with distortion. In either case, master image 400 is an image where the distortion is known. In other embodiments it is possible to have a pattern that does not have a hole for the aperture as, for example, where the pattern is transmissive so that the image of the pattern reflected off of the optical element passes through the pattern to impinge on the capture device. The pattern can be transparent or semi-transparent.

FIG. 4B depicts an example of a captured image 402 according to one embodiment. It will be understood that captured image 402 is only one example of an image that may be captured. As shown, lines 404 may be bowed inward slightly at the edge of captured image 402. This may result because of distortion in reflecting the image off of optical device 106. It should be noted that other distortion may result, such as the lines may be bowed outward, etc.

When captured image 402 is compared with master image 400, some deviation is calculated. For example, the curvature of lines 404 causes some deviation from the lines found in master image 400.

In one embodiment, image processor 104 may store and/or display the results of the deviation determination. For example, image processor 104 may store and/or display the deviation determined. Further, image processor 104 may determine if optical element 106 may be considered acceptable. For example, if the deviation is above a threshold, then it may be determined that optical element 106 passes or fails the test. In one example, it may be determined that optical element 106 is not acceptable for inclusion in a solar power generation system. This may be because its distortion is too significant to be able to focus light rays properly.

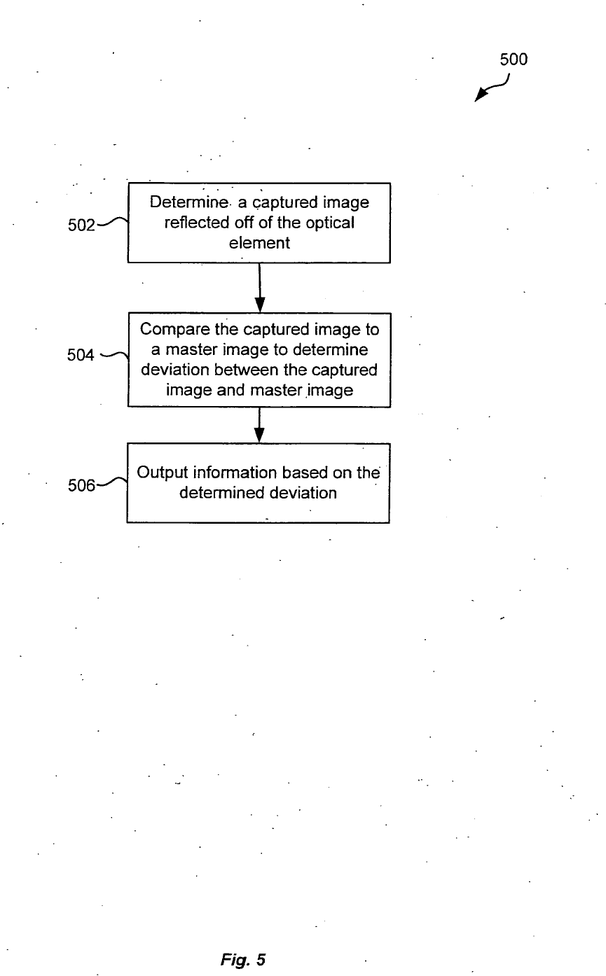

FIG. 5 depicts a simplified method of a flowchart 500 for testing optical element 106 according to one embodiment. Step 502 determines a captured image reflected off of optical element 106. For example, the image may be captured by capture device 102 and sent to image processor 104.

Step 504 compares the captured image to a master image to determine deviation between the captured image and master image. For example, image processing software may be used to determine a pattern from the captured image. This is compared to a pattern determined from the master image. Any deviation between the patterns may be-determined.

Step 506 then outputs information based on the determined deviation. For example, the information may indicate the deviation as determined and/or a pass/fail indicator.

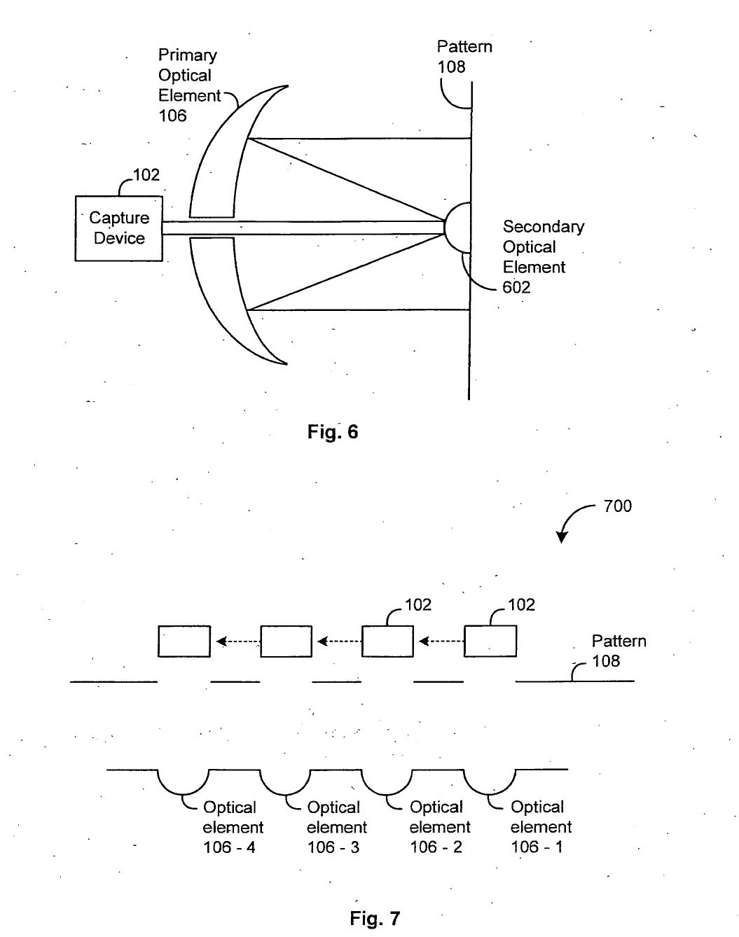

FIG. 6 depicts another embodiment of a testing system 600 according to one embodiment of the present invention. System 500 includes optical element 106, which is referred to as primary optical element 106, pattern 108, capture device 102, and a secondary optical element 602.

In this case, image to be tested 108 is reflected off of primary optical element 106 to secondary optical element 602. The pattern may be reflected and focused to a first focus area. A secondary optical element 602 may be positioned in substantially the first focus area and can then reflect the image again to a second focus area. As shown, the image is reflected by secondary optical element 602 to the second focus area through primary optical element 106.

Capture device 102 is situated such that a captured image may be taken of the reflected pattern off of secondary-optical element 602. In one embodiment, capture device 102 is situated substantially where a photovoltaic cell may be situated in a solar power generation system.

Capture device 102 may capture the pattern reflected off of both primary optical element 106 and secondary optical element 602. The captured image may then be compared with a master image to determine any deviations. Also, whether primary optical element 106 and/or or secondary optical element 602 passes or fails the test may be determined.

FIG. 7 depicts another embodiment of a testing system 700 according to embodiments of the present invention. In one embodiment, optical element 106 may be situated in an array of optical elements 106. For example, a panel of optical elements 106 may be used to collect reflected sunlight. In one embodiment, multiple capture devices 102 may be situated to capture an image from each of the optical elements 106. Further, capture device 102 may be configured to move along the array of optical elements 106 to capture images sequentially from each optical element 106. Once the images are detected, the captured images may be tested as described above.

Accordingly, particular embodiments allow the testing of optical elements 106. The tests may be performed in an efficient manner that keeps costs down but provides reliable testing. Tests may allow a user to determine whether or not an optical element 106 is acceptable or not. For example, when building solar systems, many different mirrors may be received. It is desirable to quickly test the mirror to see if the curvature is acceptable or not. For example, if the curvature does not concentrate reflected rays properly, then inserting the mirror into a solar power generation system is not desirable.

Embodiments of the present invention provide a test that is performed automatically. Thus, the user does not need to compare images or visually determine if an optical element 106 is acceptable or not. Accordingly, the test may be reliable and not subject to user error.

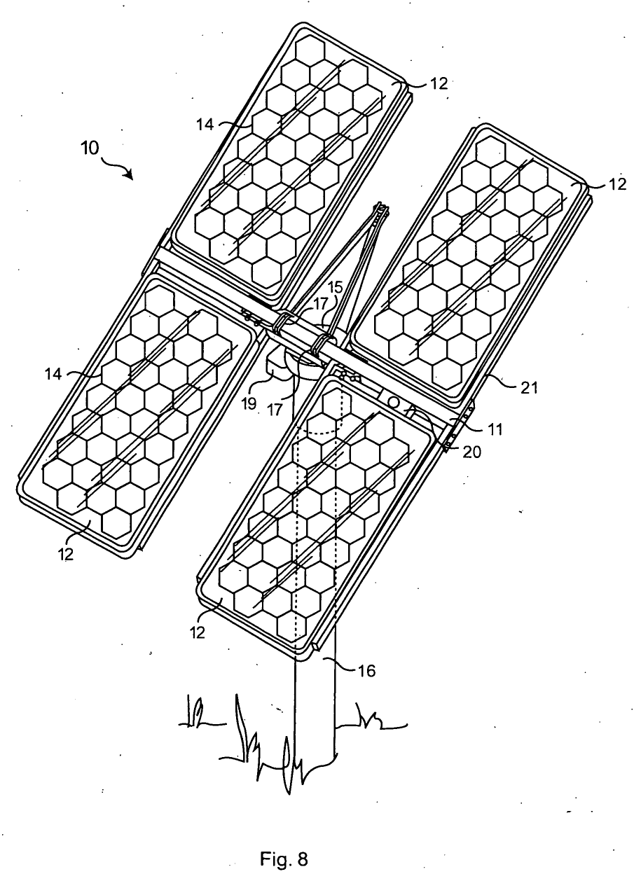

FIG. 8 depicts an example system incorporating an optical element 106 according to one embodiment. An array 10 that includes a plurality of solar panels 12 provided in a substantially planar configuration. In the example of FIG. 8, four solar panels 12 collectively form array 10, but it should be appreciated that any number of solar panels may be employed, from a single solar panel to many more than four panels. Each panel 12 houses a matrix of power units 14 that convert sunlight, or solar radiation, to electricity. In the exemplary illustration of FIG. 8, thirty-two power units 14 are shown in each solar panel 12, although this depiction should not be unnecessarily limiting to the present subject matter. A fewer or greater number of power units may be provided in each solar panel, and such power units may be provided in a variety of particular configurations. Each power unit has a mechanical arrangement which focuses solar energy to an optical rod, which conducts it to a single photovoltaic (PV) cell. These and other particular aspects of the power units will be described later in more detail.

In one embodiment, each panel 12 of array 10 measures approximately one meter by two meters and is provided with a relatively compact depth of about 10 cm, due in part to the efficiency of the optical components of each power unit. A collective assembly of four panels as depicted in FIG. 8 may form a substantially rectangular shape measuring about 2.25 meters by 4.25 meters and also characterized by a depth of 10 cm. A depth of between about two and thirty cm is generally provided in some of the disclosed exemplary embodiments. These dimensions are provided for example only and should not be limiting to the present subject matter.

The array 10 of FIG. 8 is positioned atop a mounting pole 16, which in some embodiments may be about 2.5 meters tall. A structural frame 21 is provided along the array 10 to help maintain planarity and rigidity of the assembly. Structural frame 21 is connected to a torque bar 11 that serves to rotate the assembly of solar panels 12 about its center in two axes: a front-back axis and a left-right axis. A motorized gear drive assembly 15 provided at the top of mounting pole 16 is coupled to torque bar 11 via pivot point connections 17. Gear drive assembly 15 is also coupled to a controller 19, which may correspond to a microcontroller in some embodiments. Gear drive assembly 15, controller 19, torque bar 11 and mounting pole 16 all combine to form a tracker for the solar panel array.

The tracker components illustrated in FIG. 8 collectively function to orient the respective power units 14 in optimum direction for receiving sunlight such that the PV cells therein can operate most effectively. The motorized gear assembly 15 is operated by controller 19 based on input received from a narrow range sun sensor 20 that provides accurate pointing information. In one embodiment, sun sensor 20 operates over a range of about five degrees, and is used to zero array 10 to the sun for large pointing errors. In some embodiments, sun sensor 20 is not required, such as instances where the array is generally positioned within the capture angle of certain optical components of the power units.

It should be appreciated that many other array and tracker configurations are applicable for use with the presently disclosed technology, including but not limited to ganged arrays of panels for a low profile roof mount application. Such arrays could be equatorial mounted and polar aligned so as to allow near-single axis tracking. These too could be configured to park in a downward facing position each evening or during other predetermined conditions to minimize environmental particulate accumulation and to afford further protection to the system.

Although the description has been described with respect to particular embodiments thereof, these particular embodiments are merely illustrative, and not restrictive. Although solar optical elements are discussed, it will be understood that other optical elements may be used.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated-for carrying out this invention, but that the invention will include any and all particular embodiments and equivalents falling within the scope of the appended claims.

We claim:

1. A method for testing an optical element, the method comprising:
determining an image of a pattern captured from a capture device, the pattern positioned such that the pattern is reflected off an optical element for a solar power generation system towards the capture device;
comparing the captured image to a master image; and
determining a characteristic of the optical element based on the comparison of the captured image to the master image, the characteristic useable to test the optical element for inclusion in the solar power generation system.

2. The method of claim 1, further comprising determining a deviation between the captured image and the master image, wherein the characteristic is determined based on the deviation.

3. The method of claim 1, wherein the characteristic is used to determine a pass or fail rating for the optical element for inclusion in the solar power generation system.

4. The method of claim 1, wherein the characteristic is surface aberration of the optical element.

5. The method of claim 1, wherein the characteristic is alignment of the optical element with respect to the capture device.

6. The method of claim 1, further comprising storing or displaying a result of the characteristic determination.

7. The method of claim 1, wherein the pattern is positioned at a position off of a curved surface of the optical element.

8. The method of claim 1, wherein the capture device is positioned to capture the image at a focus area for the pattern being reflected of the optical element.

9. The method of claim 1, wherein the capture device is positioned to capture the image at a focus area for the pattern that is first reflected off of the optical element to a secondary optical element, which reflects the pattern to the capture device.

10. The method of claim 1, further comprising using edge detection techniques to a representation of the pattern from the captured image.

11. The method of claim 1, wherein the capture device comprises a digital camera.

12. An apparatus for testing an optical component, the apparatus comprising:
a pattern having an aperture;
an optical element positioned with a reflective side facing the pattern;
a light source configured to provide illumination such that the pattern is reflected from the reflective side of the optical element; and
a capture device configured to capture the reflected pattern; and
an image processor configured to process the captured reflective pattern to determine a characteristic of the optical element, the characteristic useable to test the optical element for inclusion in the solar power generation system.

13. The apparatus of claim 12, wherein the image processor is configured to determine a deviation between the captured image and the master image, wherein the characteristic is determined based on the deviation.

14. The apparatus of claim 12, wherein the characteristic is used to determine a pass or fail rating for the optical element for inclusion in the solar power generation system.

15. The apparatus of claim 12, wherein the characteristic is surface aberration of the optical element.

16. The apparatus of claim 12, wherein the characteristic is alignment of the optical element with respect to the capture device.

17. The apparatus of claim 12, wherein the image processor is configured to store or display a result of the characteristic determination.

18. The apparatus of claim 12, wherein the pattern is positioned at a position off of a curved surface of the optical element.

19. The apparatus of claim 12, wherein the capture device is positioned to capture the image at a focus area for the pattern being reflected of the optical element.

20. The apparatus of claim 12, further comprising a second optical element configured to reflect the pattern reflected off to the optical element to the capture device.

21. The apparatus of claim 12, wherein the image processor is configured to use edge detection techniques to a representation of the pattern from the captured image.

22. The apparatus of claim 12, wherein the capture device comprises a digital camera.

23. An apparatus configured to test an optical element, the apparatus comprising:
logic configured to determine an image of a pattern captured from a capture device, the pattern positioned such that the pattern is reflected off an optical element for a solar power generation system towards the capture device;
logic configured to compare the captured image to a master image and logic configured to determine a characteristic of the optical element based on the comparison of the captured image to the master image, the characteristic useable to test the optical element for inclusion in the solar power generation system.

24. The apparatus of claim 23, wherein the image processor is configured to determine a deviation between the captured image and the master image, wherein the characteristic is determined based on the deviation.

25. The apparatus of claim 23, wherein the characteristic is used to determine a pass or fail rating for the optical element for inclusion in the solar power generation system.

26. The apparatus of claim 23, wherein the pattern is positioned at a position off of a curved surface of the optical element.
